(19) United States
(12) Patent Application Publication
(10) Pub. No.: US 2010/0086733 A1
(43) Pub. Date: Apr. 8, 2010

(54) ALUMINUM ALLOY SUBSTRATE AND A METHOD OF MANUFACTURING THE SAME

(75) Inventor: Hitoshi NAKATA, Nagano (JP)

Correspondence Address: ROSSI, KIMMS & McDOWELL LLP., 20609 Gordon Park Square, Suite 150, Ashburn, VA, 20147, US

(73) Assignee: FUJI ELECTRIC DEVICE TECHNOLOGY CO., LTD., Tokyo (JP)

(21) Appl. No.: 12/574,948

(22) Filed: Oct. 7, 2009

(30) Foreign Application Priority Data
Oct. 7, 2008 (JP) 2008-260840

(51) Int. Cl. B32B 15/04; B32B 3/10; B05D 3/10

(52) U.S. Cl. 428/137; 427/343

(57) ABSTRACT

An aluminum alloy substrate having nano-holes in an ordered arrangement is disclosed, as well as a method of manufacturing such an aluminum alloy substrate. The aluminum alloy substrate of the invention includes a substrate, a first underlayer, a second underlayer, and an aluminum-containing layer including a lower layer portion composed of an amorphous aluminum alloy and an amorphous surface layer portion containing alumina, the surface layer portion having a plurality of nano-holes formed thereon.

### BACKGROUND OF THE INVENTION

A. Field of the Invention

The present invention relates to an aluminum alloy substrate, and in particular, to an aluminum alloy substrate with a pattern of ordered arrangement of nano-holes. The invention also relates to a method of manufacturing such an aluminum alloy substrate, the method being capable of efficiently forming the substrate.

B. Description of the Related Art

An alumina-containing material with a plurality of nano-holes formed thereon is known as a material for embedding a magnetic material in the process of forming a patterned medium such as a high density hard disk. The alumina-containing material is obtained by oxidizing an anode of an aluminum-containing material in an acidic electrolytic solution, and is a porous material with nano-holes of a uniform diameter arranged on the surface of the material. The porous material is expected today for applications to various nano devices. An example of such applications has been disclosed as described below.

Publication of Japanese Translation of PCT International Application No. 2002-503009, and Publication of PCT International Application WO99/40575, disclose a magnetic recording medium comprising a non-magnetic substrate; a layer comprising aluminum (Al) or an Al alloy on the substrate, the layer having a substantially uniform pattern thereon; and a magnetic layer; wherein the pattern is substantially replicated on the magnetic layer to form a data zone. This magnetic recording medium is a perpendicular magnetic recording medium produced by embedding magnetic materials in cells formed in a substantially honeycomb pattern.

In the medium disclosed in Publication of Japanese Translation of PCT International Application No. 2002-503009, and Publication of PCT International Application WO99/40575, magnetic anisotropy perpendicular to the medium surface (perpendicular magnetic anisotropy) is achieved by embedding ferromagnetic materials in the cells formed along the perpendicular direction to provide a recording medium exhibiting perpendicular magnetic anisotropy. Such media are expected for magnetic recording media in the next generation exhibiting high recording density with increasing requirements for improvement.

One of the other application examples of the porous material is a technique to utilize the material as a template for fabricating a fine mold. In this technique, a mother die of a metal such as nickel or a resin is first prepared for forming nano-holes; then, a porous material is obtained using this mother die; and finally, a fine mold is fabricated.

Thus, various techniques have been disclosed to form nano-holes by oxidizing an anode of an aluminum-containing material. The following describes a process of nano-hole growth in alumina in those techniques.

First, alumina is generated by oxidation of the surface portion of the aluminum-containing layer with oxygen ions in the solution. Then, aluminum ions generated at interfaces between the unoxidized aluminum and the oxidized alumina diffuse into the solution through the alumina in the surface portion, to effect the nano-hole growth in the alumina. Thus, the nano-hole growth is effected by diffusion of oxygen in the solution into the aluminum and diffusion of the aluminum ions in the aluminum into the solution.

An example of a conventional technique for forming nano-holes is shown in FIGS. 4(a), 4(b), and 4(c). FIGS. 4(a) through 4(c) are sectional views successively depicting a process of nano-hole formation in a conventional technique, in which FIG. 4(a) shows a step of successively forming underlayers of titanium film 44 and gold film 46 on substrate 42 by vapor deposition or sputtering, FIG. 4(b) shows a step of forming aluminum film 48 on gold film 46 by sputtering to obtain lamination 50, and FIG. 4(c) shows a step of immersing lamination 50 into electrolytic solution 54 filled in bath 52. In the step shown in FIG. 4(c), electrode 56 is provided opposing lamination 50 and a voltage is applied between an anode of lamination 50 and a cathode of electrode 56, to form nano-holes in alumina on the surface of aluminum film 48.

In accordance with increasing requirement for higher recording density of the medium, the nano-holes in alumina (called “cells” in Publication of Japanese Translation of PCT International Application No. 2002-503009, and Publication of PCT International Application WO99/40575) in the porous material, when each of the nano-holes is used as one bit in a magnetic recording medium, need to be made in high density. Specifically, a pitch between the holes can be considered to be reduced. Since the pitch between the nano-holes is proportional to the applied voltage on oxidation of the anode, decrease in the applied voltage can reduce the pitch between the nano-holes.

However, in the early stage of the oxidation, the growth rate of the holes in the direction perpendicular to the film surface is also proportional to the applied voltage. As a consequence, the decrease in applied voltage requires a long time for forming nano-holes having a predetermined depth. Formation of nano-holes 500 nm deep with a pitch of 25 nm under an applied voltage of 10 V, for example, consumes about 3 hours, which cannot be regarded as an efficient process for forming nano-holes.

In the process of forming the porous material comprising alumina, the nano-holes grow from starting points of micro pits on the aluminum surface. Utilizing this property of the aluminum, arrangement control of the nano-holes can be performed, for example, by forming micro pits on the aluminum surface by an imprinting technique using a mold.

However, due to random existence of grain boundaries in aluminum itself in the aluminum thin film deposited by sputtering, the nano-holes are formed randomly from the starting points of the grain boundaries, inhibiting ordered arrangement of nano-holes.

The present invention is directed to overcoming or at least reducing the effects of one or more of the problems set forth above.

### SUMMARY OF THE INVENTION

In view of the above issues, it is desired to provide an aluminum alloy substrate having nano-holes in ordered arrangement. It is also desired to provide a method of manufacturing efficiently such an aluminum alloy substrate.

An aluminum alloy substrate of the invention comprises a substrate, a first underlayer, a second underlayer, and an aluminum-containing layer including a lower layer portion composed of an amorphous aluminum alloy and an amorphous surface layer portion containing alumina, the surface layer portion having a plurality of nano-holes formed thereon. An aluminum alloy substrate according to the invention can be used for embedding magnetic materials in a process of forming a patterned medium of a high density hard disk.

An aluminum alloy of the aluminum alloy substrate is preferably selected from an Al—Mo alloy, an Al—Ta alloy, an Al—Ti alloy, and an Al—W alloy.

A method of manufacturing an aluminum alloy substrate according to the present invention comprises a step of successively forming a first underlayer and a second underlayer on a substrate, a step of forming an aluminum-containing layer composed of an amorphous aluminum alloy on the second underlayer, and a step of oxidizing the aluminum-containing layer to form an amorphous alumina-containing layer having a plurality of nano-holes formed in a surface layer portion thereof.

An aluminum alloy in the method of manufacturing an aluminum alloy substrate is preferably selected from an Al—Mo alloy, an Al—Ta alloy, an Al—Ti alloy, and an Al—W alloy.

An aluminum alloy substrate of the invention having the construction as specified above achieves an ordered arrangement of nano-holes. A method of manufacturing an aluminum alloy substrate having the constitution as specified above achieves efficient formation of an ordered arrangement of nano-holes. Consequently, use of the technology on an aluminum alloy substrate according to the invention allows a high density hard disk to be manufactured with high precision in a short time by embedding magnetic materials in the nano-holes in a process of manufacturing a magnetic recording medium utilizing the processed substrate. The use of the technology on an aluminum alloy substrate according to the invention further allows a nickel mold, for example, to be manufactured with high precision in a short time by utilizing electrocasting technique afterwards.

### BRIEF DESCRIPTION OF THE DRAWINGS

The foregoing advantages and features of the invention will become apparent upon reference to the following detailed description and the accompanying drawings, of which:

FIG. 1 is a sectional view of an aluminum alloy substrate according to the invention;

FIGS. 2 (a), 2(b), and 2(c) are sectional views showing a method of manufacturing an aluminum alloy substrate of the invention, in which FIG. 2(a) shows a step of successively forming first underlayer 14 and second underlayer 16 on substrate 12, FIG. 2(b) shows a step of forming aluminum-containing layer 18 on the lamination obtained in the step shown in FIG. 2(a); and FIG. 2(c) shows a step of oxidizing lamination 20 obtained in the step shown in FIG. 2(b) to obtain aluminum alloy substrate 10;

FIGS. 3(a) through 3(f) are sectional views showing steps for forming a nickel mold using an aluminum alloy substrate of the invention, in which FIG. 3(a) shows a step of forming resist film 32 on lamination 20; FIG. 3(b) shows a step of imprinting on resist film 32 on the lamination obtained in the step of FIG. 3(a) using mold 34; FIG. 3(c) shows a step of conducting reactive ion etching on resist film 32 imprinted in the step of FIG. 3(b) to form micro pits 18a; FIG. 3(d) shows a step of immersing the lamination obtained after the step of FIG. 3(c) into an electrolytic solution to obtain an aluminum alloy substrate having nano-holes 18b thereon; FIG. 3(e) shows a step of nickel electrocasting using the aluminum alloy substrate obtained in the step of FIG. 3(d) as a template to obtain a nickel mold 36; and FIG. 3(f) shows a step of releasing nickel mold 36 formed in the step of FIG. 3(e) from the aluminum alloy substrate; and

FIGS. 4(a), 4(b), and 4(c) are sectional views showing a conventional method of manufacturing an aluminum alloy substrate.

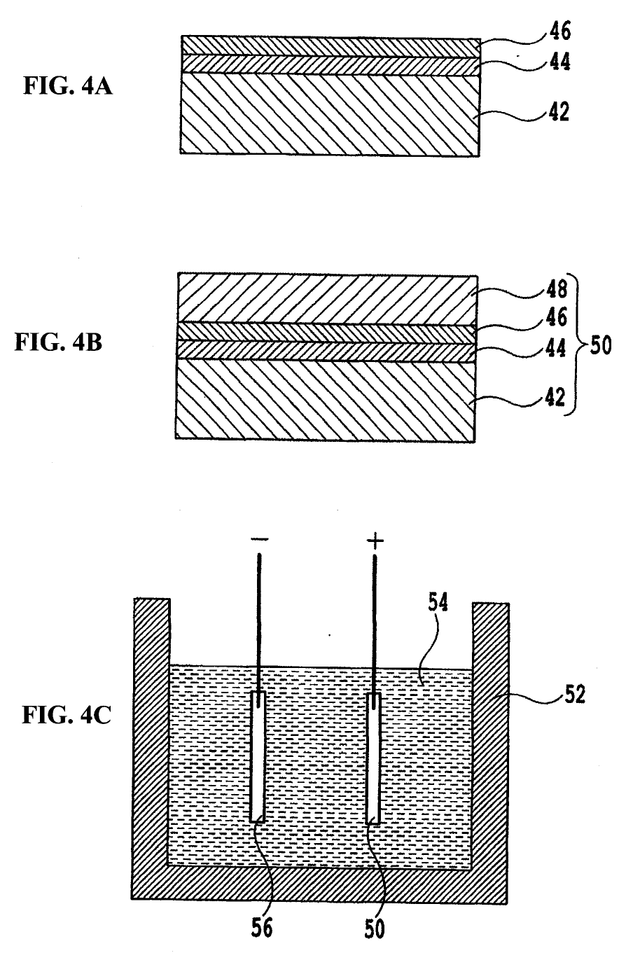

### DETAILED DESCRIPTION OF SPECIFIC EMBODIMENTS

An aluminum alloy substrate and a method of manufacturing the substrate, and a method of manufacturing a mold utilizing an aluminum alloy substrate of the invention will be described in detail in the following with reference to accompanying drawings. It is to be understood that the following examples are only illustrative ones for embodiment of the invention and can be changed and modified by those skilled in the art.

### Aluminum Alloy Substrate

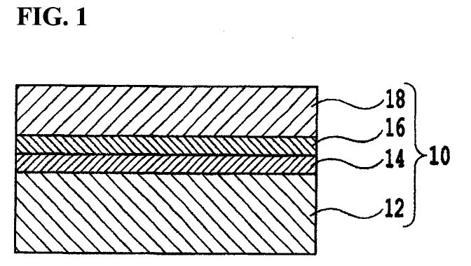

FIG. 1 is a schematic sectional view of an aluminum alloy substrate of the invention. Referring to FIG. 1, aluminum alloy substrate 10 comprises substrate 12, first underlayer 14, second underlayer 16, and aluminum-containing layer 18 provided in this order. Detailed description of components 12 through 18 are given in the following.

Substrate 12

Substrate 12 is a component used at the bottom of aluminum alloy substrate 10 for successively forming and supporting other components 14 through 18, which will be described later, of aluminum alloy substrate 12. Substrate 12 can be composed of materials commonly used in magnetic recording media including a NiP-plated aluminum alloy, strengthened glass, crystallized glass, and in addition, a silicon substrate.

First Underlayer 14

First underlayer 14 is a component disposed directly on substrate 12 for the purpose of improving adhesiveness between substrate 12 and second underlayer 16. First underlayer 14 is satisfied by good adhesiveness with a metallic film and can be composed of titanium or tantalum and the like, among which titanium is preferable in view of easy oxidation.

Second Underlayer 16

Second underlayer 16 is a component disposed on first underlayer 14 for the purpose of stopping the growth of nano-holes and performing a function as an electrode in electro-plating. Second underlayer 16 is satisfied by a hardly oxidized property and a high electric conductivity, and can be composed of gold, silver or the like, among which gold is preferable in view of a hardly oxidized property.

A thickness of second underlayer 16 is preferably in the range of 50 nm to 100 nm. A thickness not larger than 100 nm contributes to planarization of a film formed on second underlayer 16.

Aluminum-Containing Layer 18

Aluminum-containing layer 18 is a component comprising a lower layer portion composed of an amorphous aluminum alloy and a surface layer portion containing amorphous alumina, the latter having a plurality of nano-holes with a predetermined diameter formed thereon in ordered arrangement. By embedding magnetic materials in the nano-holes afterwards, a recording medium exhibiting desired perpendicular magnetization anisotropy is obtained. The aluminum-containing layer 18 is satisfied by providing with this function and can be composed of a material containing aluminum and optionally, Ta, Mo, Ti, W, and the like.

Aluminum-containing layer 18 has a plurality of nano-holes on the surface layer portion thereof as described above. A diameter of the nano-holes not larger than 50 nm provides an aluminum alloy substrate suited for producing a medium with high recording density.

The surface layer portion of aluminum-containing layer 18 is an amorphous layer containing alumina, and consequently free of a grain boundary of aluminum. Therefore, the surface layer portion does not have irregularly arranged nano-holes that would be formed from starting points of aluminum grain boundaries, hence achieving ordered arrangement of nano-holes on the whole surface layer portion.

A thickness of aluminum-containing layer 18 not larger than 500 nm allows magnetic materials being readily embedded in the nano-holes.

Since the surface layer portion of aluminum-containing layer 18 of aluminum alloy substrate 10 is an alumina-containing amorphous layer as described above, ordered arrangement of the nano-holes is achieved. Therefore, aluminum alloy substrate 10 can be favorably used for manufacturing a high density magnetic recording medium by embedding magnetic materials into such nano-holes. Moreover, aluminum alloy substrate 10 can be favorably used for manufacturing a nickel mold, for example, by conducting electrocasting in the nano-holes.

### Method of Manufacturing an Aluminum Alloy Substrate

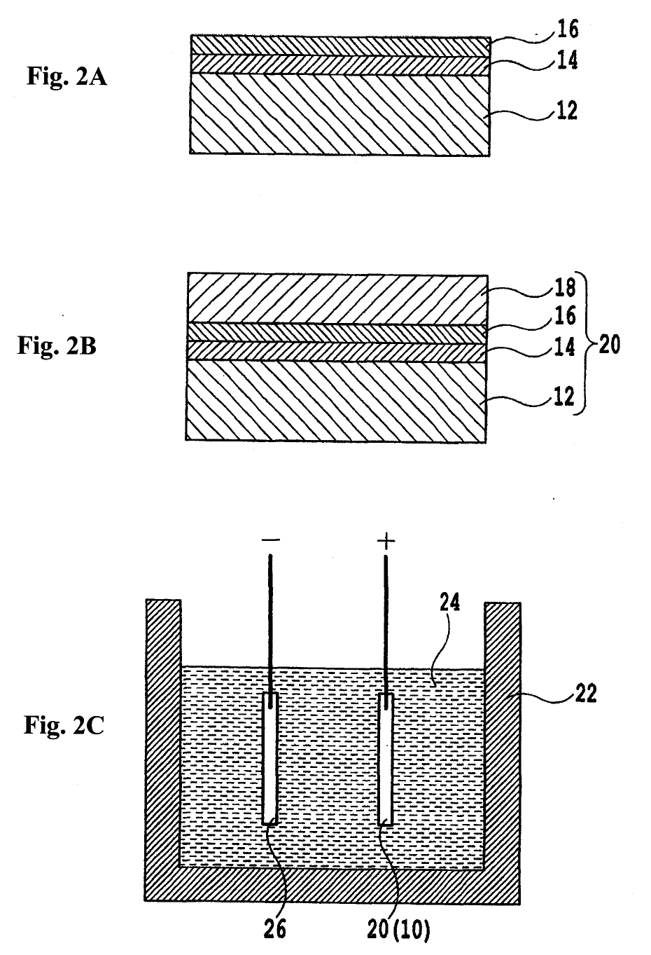

FIGS. 2(a), 2(b), and 2(c) are sectional views showing sequentially a method of manufacturing an aluminum alloy substrate according to the invention, in which FIG. 2(a) shows a step (a first step) of successively forming first underlayer 14 and second underlayer 16 on substrate 12, FIG. 2(b) shows a step (a second step) of forming aluminum-containing layer 18 on the lamination obtained in the first step, and FIG. 2(c) shows a step (a third step) of oxidizing lamination 20 obtained in the second step to obtain aluminum alloy substrate 10. The steps 1 through 3 are described in detail in the following.

First Step

This step is a step of forming successively first underlayer 14 and second underlayer 16 on substrate 12 as shown in FIG. 2(a). Preferred materials and thicknesses of substrate 12, underlayers 14, 16 have been described in the part of the specification on the aluminum alloy substrate.

It is preferable to clean substrate 12 before forming other components 14 through 18. The cleaning can be carried out by way of scrubbing with a blush, high pressure water jet, or immersion in an alkali detergent. Ultraviolet light irradiation can be further conducted after cleaning by one of those methods.

Both first underlayer 14 and second underlayer 16 can be formed by any methods and conditions known in the art such as sputtering methods (including a DC magnetron sputtering method and an RF magnetron sputtering method) and a vacuum deposition method. A sputtering method is preferable in view of flatness of the film surface

Second Step

The second step as shown in FIG. 2(b) is a step of forming aluminum-containing layer 18 on the lamination obtained in the first step. Preferred materials and thicknesses of aluminum-containing layer 18 have been described in the part of the specification on the aluminum alloy substrate. Aluminum-containing layer 18 can be formed by any methods and conditions known in the art such as sputtering methods (including a DC magnetron sputtering method and an RF magnetron sputtering method) and a vacuum deposition method. A sputtering method is preferable in view of flatness of the aluminum film surface.

Third Step

The third step as shown in FIG. 2(c) is a step of oxidizing lamination 20 obtained in the second step, to obtain aluminum alloy substrate 10. In the process of oxidizing lamination 20, electrolytic solution 24 is filled in bath 24 as depicted in FIG. 2(c), and an anode of lamination 20 and separate cathode 26 apart from lamination 20 are immersed in solution 24, and a voltage is applied between anode 20 and cathode 26 opposing in solution 24, to obtain aluminum alloy substrate 10.

Electrolytic solution 24 is sufficiently an acidic liquid for example, an aqueous solution of oxalic acid, phosphoric acid, sulfuric acid or the like. A concentration of the aqueous solution is preferably in the range of 0.2 to 0.5 mol/L.

Cathode 26 can be composed of platinum, for example.

Preferred conditions in oxidizing the anode of lamination 20 are as follows. A temperature of solution 24 is preferably in the range of 1 to 5° C. in view of the growth rate of the nano-holes. An application voltage is not greater than 10 V. Under these oxidation conditions, nano-holes with a depth of 500 nm and a pitch of 25 nm can be formed in about 1.5 hours, thus performing efficient formation of the nano-holes.

On application of a voltage to electrodes 20 and 26 under this arrangement of components, the surface layer portion of aluminum-containing layer 18 disposed at the top of lamination 20 is oxidized with the oxygen ions in the solution, forming a layer containing alumina. Then, aluminum ions generated at the interfaces between the unoxidized aluminum alloy and the oxidized alumina-containing layer diffuse through the alumina-containing layer in the surface layer portion into the solution, performing growth of nano-holes in the alumina-containing layer.

In order to form the nano-holes in a short time, which means efficient formation of the nano-holes, the diffusion rate of the oxygen ions and the diffusion rate of the aluminum ions are adequately enhanced. Specifically, aluminum-containing layer 18 composed of an amorphous aluminum alloy, owing to increased diffusion coefficients thereof, enhances diffusion rate of oxygen ions and diffusion rate of aluminum ions, performing efficient formation of nano-holes.

In the method of manufacturing aluminum alloy substrate 10 as described above, aluminum-containing layer 18 is formed of an amorphous aluminum alloy. By virtue of increased diffusion coefficients, diffusion rates of oxygen ions and aluminum ions are enhanced achieving efficient formation of nano-holes. In aluminum alloy substrate 10 obtained by this manufacturing method, amorphous alumina is generated on the surface of aluminum-containing layer 18, forming nano-holes of ordered arrangement with high precision. Therefore, the method of manufacturing an aluminum alloy substrate can be used for favorably manufacturing a high density magnetic recording medium and manufacturing a nickel mold.

### Method of Manufacturing a Mold Using an Aluminum Alloy Substrate

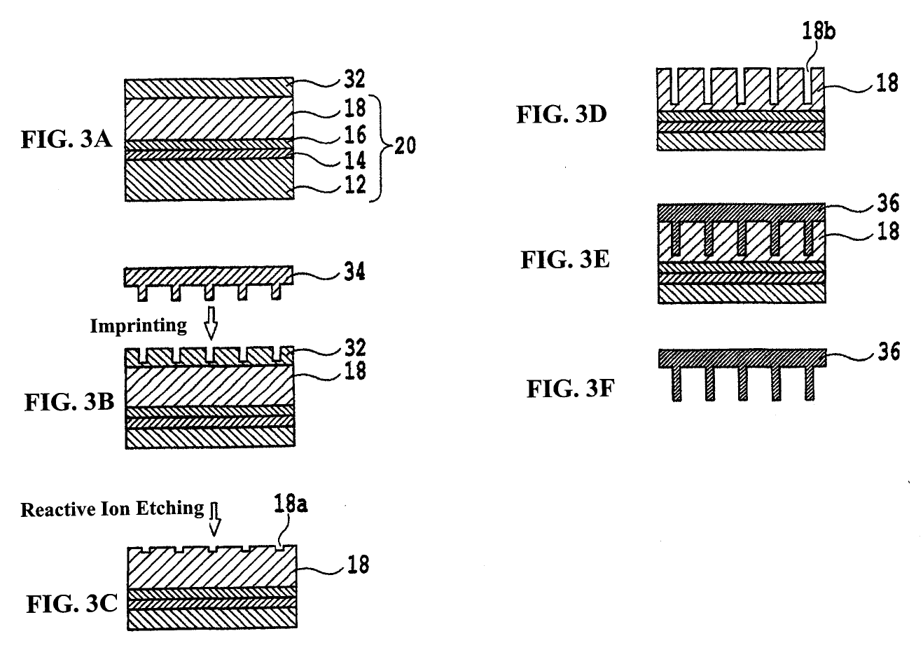

FIGS. 3(a) through 3(f) are sectional views successively showing a method of manufacturing a mold using an aluminum alloy substrate according to the invention, in which FIG. 3(a) shows a step (a first step) for forming resist film 32 on lamination 20 shown in FIG. 2(b), FIG. 3(b) shows a step (a second step) of imprinting on resist film 32 of the lamination obtained in the first step, using mold 34, FIG. 3(c) shows a step (a third step) of reactive ion etching on resist film 32 imprinted in the second step, to form micro pits 18a, FIG. 3(d) shows a step (a fourth step) of immersing the lamination obtained in the third step into the electrolytic solution shown in FIG. 2(c), to obtain an aluminum alloy substrate having nano-holes 18b formed thereon, FIG. 3(e) shows a step (a fifth step) of thick plating of nickel mold 36 by means of nickel electrocasting using a template of the aluminum alloy substrate obtained in the fourth step, and FIG. 3(f) shows a step (a sixth step) of releasing nickel mold 36 obtained in the fifth step from the aluminum alloy substrate. These steps of manufacturing a mold described above must be preceded by the steps of manufacturing an aluminum alloy substrate of the invention described previously. Details of the latter steps including steps of forming lamination 20 shown in FIG. 2(b), for example, have been described in the previous sections of the specification and omitted here.

First Step

The first step as shown in FIG. 3(a) is a step of forming resist film 32 on lamination 20 shown in FIG. 2(b). Resist film 32 can be composed of a UV-curable resist or a thermosetting resist, among which an SOG (spin on glass) resist film is preferable in view of heat resistance.

Resist film 32 can be formed by means of a spin-coater.

Second Step

The second step as shown in FIG. 3(b) is a step of imprinting on resist film 32 of the lamination obtained in the first step using mold 34.

Third Step

The third step as shown in FIG. 3(c) is a step of reactive ion etching on resist film 32 imprinted in the second step. In the conditions of the ion etching, a gas to be used can be selected from Cl₂, O₂, and CF₄, among which CF₄ gas is preferable in view of a selective etching ratio. This ion etching step removes resist film 32 and simultaneously forms the micro pits on aluminum-containing layer 18 in the same pattern as mold 34.

Fourth Step

The fourth step as shown in FIG. 3(d) is a step of immersing the lamination obtained in the third step in the electrolytic solution shown in FIG. 2(c) to obtain an aluminum alloy substrate having nano-holes 18b formed thereon. In this fourth step, nano-holes 18b with a predetermined depth are formed in the same pattern as the micro pits 18a preliminarily formed in the third step.

Fifth Step

The fifth step as shown in FIG. 3(e) is a step of electrocasting using the aluminum alloy substrate obtained in the fourth step as a template and thickly plating the surface of aluminum-containing layer 18 with nickel to obtain a nickel mold.

Sixth Step

The sixth step as shown in FIG. 3(f) is a step of releasing nickel mold 36 formed in the fifth step from the aluminum alloy substrate.

The method of manufacturing a mold as described hereinbefore, using an aluminum alloy substrate having nano-hoes in an ordered arrangement that is efficiently accomplished according to the invention, provides a desired mold with high precision in a short time.

### Examples

The effects of the invention will be demonstrated with reference to some preferred embodiment examples in the following. It should be acknowledged that the examples are illustrative representatives and not restrictive.

### Study on Rate of Forming the Nano-Holes on an Aluminum Alloy Substrate

### Formation of Aluminum Alloy Substrate

### Example 1

Aluminum alloy substrate 10 having a structure of FIG. 1 was formed by a manufacturing method shown in FIGS. 2(a), 2(b) and 2(c). Substrate 12 of silicon substrate 0.63 mm thick was prepared. After introducing the substrate into a sputtering apparatus, successively formed were first underlayer 14 of a titanium film with a thickness of 50 nm by sputtering and second underlayer 16 of a gold film with a thickness of 100 nm by sputtering, as shown in FIG. 2(a).

Subsequently as shown in FIG. 2(b), aluminum-containing layer 18 of an amorphous material was formed with a thickness of 500 nm on second underlayer 16 by co-sputtering of aluminum and tantalum.

Then as shown in FIG. 2(c), the lamination including aluminum-containing layer 18 was immersed in electrolytic solution 24 of 0.3 mol/L aqueous solution of oxalic acid filled in bath 22 to oxidize the surface of aluminum-containing layer 18. Thus, aluminum alloy substrate 10 of Example 1 was obtained. In this oxidation step, lamination 20 as shown in FIG. 2(b) was used for an anode and cathode 26 of platinum was used opposing the anode. Temperature of the aqueous solution of oxalic acid was 5° C., and an applied voltage was 10 V. Resulted oxidation time of the anode of the lamination was 90 minutes.

### Example 2

Aluminum alloy substrate 10 of Example 2 was obtained in the same manner as in Example 1 except that molybdenum was used in place of tantalum.

### Example 3

Aluminum alloy substrate 10 of Example 3 was obtained in the same manner as in Example 1 except that titanium was used in place of tantalum.

### Example 4

Aluminum alloy substrate 10 of Example 4 was obtained in the same manner as in Example 1 except that tungsten was used in place of tantalum.

Evaluation of Rate of Forming Nano-Holes

Studies were made on the rate of forming nano-holes in the aluminum-containing layer in the steps of forming the aluminum alloy substrate of Examples 1 through 4. The studies were carried out by sectional SEM observation.

The observation revealed that the rate of forming nano-holes were about 6 nm/min in all of the aluminum alloy substrates of Examples 1 through 4. When the nano-holes are formed by the method disclosed in Publication of Japanese Translation of PCT International Application No. 2002-503009, and Publication of PCT International Application WO99/40575, the rate of forming nano-holes is known to be about 3 nm/min. Thus, the rate of forming nano-holes has been doubled in the aluminum alloy substrates of Examples 1 through 4 according to the invention as compared with the conventional technology. Therefore, it can be stated that the invention has provided an efficient method of forming nano-holes. This effect has been achieved by the invention in which superior diffusion velocity of the oxygen ions and the aluminum ions has been attained in the process of oxidizing the surface layer portion of aluminum-containing layer 18 that are composed of an amorphous material.

Studies on Precision of Arrangement in the Pattern of the Mold Formed Using an Aluminum Alloy Substrate

Formation of Mold

### Example 5

A nickel mold was formed through the steps shown in FIGS. 3(a) through 3(f). First, first underlayer 14 and second underlayer 16 were formed on substrate 12 as in Example 1. Subsequently, aluminum-containing layer 18 of an amorphous material was formed.

Then, as shown in FIG. 3(a), an SOG resist was applied on aluminum-containing layer 18 to a thickness of 20 nm by a spin-coater, and subsequently imprinting was conducted using mold 34 with a dot pitch of 40 nm as illustrated in FIG. 3(b).

Then as shown in FIG. 3(c), reactive ion etching was conducted removing SOG resist 32 and simultaneously forming micro pits 18a on aluminum-containing layer 18 of an amorphous material, the micro pits being arranged in the pattern same as in mold 34. A depth of micro pits 18a was about 5 nm.

Subsequently as shown in FIG. 3(d), an oxidation treatment was conducted in the same conditions as those taken in the Example 1, to form nano-holes 18b from the starting points of micro pits 18a vertically downwards to a depth of 50 nm from the film surface of aluminum-containing layer 18. After the treatment, the aluminum in the circumference of nano-holes 18b was oxidized producing an alumina-containing layer.

Finally as shown in FIG. 3(e), nickel was electrocasted generating a thick plating using the aluminum alloy substrate as a template, to form nickel mold 36; and as shown in FIG. 3(f), mold 36 was released from the aluminum alloy substrate. Thus, nickel mold 36 of Example 5 was obtained.

### Example 6

Nickel mold 36 of Example 6 was obtained in the same manner as in Example 5 except that nano-holes 18b were formed using molybdenum in place of tantalum.

### Example 7

Nickel mold 36 of Example 7 was obtained in the same manner as in Example 5 except that nano-holes 18b were formed using titanium in place of tantalum.

### Example 8

Nickel mold 36 of Example 8 was obtained in the same manner as in Example 5 except that nano-holes 18b were formed using tungsten in place of tantalum.

Evaluation of Precision of Nickel Mold

Studies were conducted on the configuration of the pattern of the nickel molds of Examples 5 through 8 in comparison with the configuration of the pattern of mold 34 used in the imprinting step. The studies were carried out by surface SEM observation.

The observation revealed that all the pattern configurations of the nickel molds of Examples 5 through 8 completely agreed with the pattern configurations of molds 34 used in the imprinting step within the precision level of the SEM observation. When the nano-holes are formed by the method disclosed in Publication of Japanese Translation of PCT International Application No. 2002-503009, and Publication of PCT International Application WO99/40575, the pattern configuration of nickel molds are known not to agree with the pattern configuration of mold 34 used in the imprinting step within such a precision level. Thus, it can be stated that the use of an aluminum alloy substrate according to the invention accomplishes formation of a higher precision mold as compared with the conventional technology. This effect has been achieved by the invention in which aluminum grain boundaries have been completely eliminated from the region of nano-hole formation and nano-holes have been formed in an ordered arrangement in aluminum-containing layer 18 that are composed of an amorphous material.

In the aluminum alloy substrate according to the present invention, the surface layer portion of the aluminum-containing layer is an amorphous alumina-containing layer, and the nano-holes are formed in this layer. As a result, aluminum grain boundaries are completely eliminated from the region of nano-hole formation accomplishing ordered arrangement of nano-holes. In the method of manufacturing an aluminum alloy substrate according to the invention, the aluminum-containing layer is formed of an amorphous material thereby attaining a favorable diffusion velocity of oxygen and other element to form the nano-holes efficiently. Therefore, the present invention is advantageous for providing an aluminum alloy substrate efficiently and with high precision in the field of recording media in which increasing requirement for high density recording is anticipated.

Thus, an aluminum alloy substrate and a method of manufacturing the same have been described according to the present invention. Many modifications and variations may be made to the techniques and structures described and illustrated herein without departing from the spirit and scope of the invention. Accordingly, it should be understood that the devices and methods described herein are illustrative only and are not limiting upon the scope of the invention.

This application is based on, and claims priority to, Japanese Patent Application No. 2008-260840, filed on Oct. 7, 2008. The disclosure of the priority application in its entirety, including the drawings, claims, and the specification thereof, is incorporated herein by reference.

### DESCRIPTION OF SYMBOLS

10: aluminum alloy substrate
12: substrate
14: first underlayer
16: second underlayer
18: aluminum-containing layer
18a: micro pits
18b: nano-hole
20: lamination (anode)
22: bath
24: electrolytic solution
26: cathode
32: resist film (SOG resist)
34: mold
36: nickel mold

What is claimed is:

1. An aluminum alloy substrate comprising:
a substrate;
a first underlayer;
a second underlayer; and
an aluminum-containing layer including a lower layer portion composed of an amorphous aluminum alloy and an amorphous surface layer portion containing alumina, the surface layer portion having a plurality of nano-holes formed thereon.

2. The aluminum alloy substrate according to claim 1, wherein the aluminum alloy is selected from the group consisting of an Al—Mo alloy, an Al—Ta alloy, an Al—Ti alloy, and an Al—W alloy.

3. A method of manufacturing an aluminum alloy substrate comprising:
a step of successively forming a first underlayer and a second underlayer on a substrate;
a step of forming an aluminum-containing layer composed of an amorphous aluminum alloy on the second underlayer; and
a step of oxidizing the aluminum-containing layer to form an amorphous alumina-containing layer having a plurality of nano-holes formed in a surface layer portion of the aluminum-containing layer.

4. The method of manufacturing an aluminum alloy substrate according to claim 3, wherein the aluminum alloy is selected from the group consisting of an Al—Mo alloy, an Al—Ta alloy, an Al—Ti alloy, and an Al—W alloy.
